(19) United States
(12) Patent Application Publication
(10) Pub. No.: US 2024/0370856 A1
(43) Pub. Date: Nov. 7, 2024

(54) SYSTEM AND METHOD FOR CREATING AND MANAGING NON-FUNGIBLE TOKENS

(71) Applicant: Stephen Ennis, Edmonton (CA)

(72) Inventor: Stephen Ennis, Edmonton (CA)

(73) Assignee: MyGeo Tokens Inc., Edmonton (CA)

(21) Appl. No.: 18/654,068

(22) Filed: May 3, 2024

Related U.S. Application Data
(60) Provisional application No. 63/463,612, filed on May 3, 2023.

(51) Int. Cl. G06Q 20/36

(52) U.S. Cl. CPC G06Q 20/3678

(57) ABSTRACT

A system and method for creating, collecting, and managing non-fungible tokens (NFT) is disclosed. The system comprises a computing device in communication with a database via a network. Further, a first user device associated with a first user and a second user device associated with a second user is in communication with the computing device. The computing device is configured to receive information related to digital assets from the first user. The computing device is further configured to receive the digital asset from the first user. The computing device is configured to receive a geographic information determined by the first user to trade the digital asset and associate the digital asset to the geographic information. Further, a NFT comprising the digital asset is created. The computing device enables to trade the NFT when a geographic information of second user corresponds to the geographic information of the digital asset.

### CROSS-REFERENCE TO RELATED APPLICATION

The present application claims priority of U.S. Provisional Patent Application No. 63/463,612, filed on 3 May 2023 entitled “System and Method for Creating and Managing Non-Fungible Tokens”, the contents of which are hereby incorporated by reference in their entirety.

### TECHNICAL FIELD

The present invention generally relates to digital assets. More specifically, the present invention relates to a system and method for creating, collecting, and managing non-fungible tokens.

### BACKGROUND

Generally, digital asset refers to a digital form of data that has value. Examples of digital assets are photo files, video files, animations, audio files, and graphic files. Existing technologies enable a creator to create the digital assets in the form of art, image, video, audio, or any digital asset and sell the digital assets to any collectors around the globe. However, the lack of efficient approach or system for collectors to search for desired digital assets limits the capacity to monetize the digital asset. Consequently, creators also face limitations in monetizing their digital assets. Further, it is difficult to manage a set of digital assets and the transactions related to the digital asset manually. Further, the utility of digital data files is restricted to their function. Thus, the value of a digital media file is limited to the content of the file itself. For example, a digital scenic image may interest a first group of people and the digital scenic image may not interest a second group of people. The second group of people will see the digital scenic image as a simple image, which decreases the value of the digital scenic image. The creator or owner of the digital media is therefore limited in capacity to monetize a file. Therefore, a system and method to modify media files to add value to their structure is desired.

Few existing patent applications attempt to address the problems cited in the background as prior art over the presently disclosed subject matter and are explained as follows.

U.S. Ser. No. 11/367,060B1 assigned to Creator Proof LLC, entitled “Collaborative video non-fungible tokens and uses thereof” discloses a computer implemented collaborative NFT method. The system is configured to receive and store a set of files. Each file comprises digital content. The system is further configured to receive and store the digital input specifying a final digital composition. The final digital composition is stored in a database as a digital object. The digital input specifies an allocation of authorship shares representing a distribution of ownership rights in the digital object. The system is configured to mint, on a blockchain, an NFT comprising a reference to the digital object. A smart contract specifying fractional ownership of the digital object is created in the blockchain.

US20220114600A1 assigned to Scientia Potentia Est LLC, entitled “System for verification and management for non-fungible tokens” discloses a computerized system for verification and management of a digital asset. The system is configured to a digital asset from a creator of the digital asset. The system is further configured to receive identification information using a sensor of the creator. The system is further configured to receive location information representing a physical location where the identification information is received. The system is configured to create a digital asset record that includes a unique identifier associated with the digital asset, identification information and location information. However, the existing prior arts lack to provide an efficient approach to manage and monetize the digital assets.

Therefore, there is a need for an improved system and method that overcomes one or more of the above-mentioned limitations.

### SUMMARY

The present invention discloses a system and method for creating and managing non-fungible tokens. The system comprises a computing device in communication with a database via a network. The system further comprises a first user device associated with a first user and a second user device associated with a second user. The first user device and the second user device are in communication with the computing device via the network.

The database stores information related to the first user, information related to the second user and information related to the non-fungible tokens. The computing device comprises a set of program modules and at least one processor configured to execute one or more modules stored in a memory. The modules comprise an input module, a location module, a tokenization module, a search module, a trade module and a payment module.

The input module is configured to receive information related to at least one digital asset from the first user, and receive the digital asset from the first user. The location module is configured to receive a geographic information determined by the first user to trade the digital asset and associate the digital asset to the geographic information. The geographic information includes a geographic boundary. The location module enables the first user to mark the geographic boundary on a geographic map and links the digital asset to the geographic boundary. The location module is configured to determine the geographic information of the first user using at least one of GPS, Bluetooth, Wi-Fi, hotspot, Global Navigation Satellite System (GNSS) and mobile network of the first user device.

The tokenization module is configured to create a non-fungible token (NFT) comprising the digital asset. The search module is configured to search one or more non-fungible tokens using one or more criteria received from the second user and display one or more non-fungible tokens relevant to the criteria. In one embodiment, the criteria include, but not limited to, token name, places, popular tokens, tags and location proximal to the second user to collect tokens.

The location module is further configured to determine a geographic information of the second user. The location module is configured to determine the geographic information of the second user using at least one of GPS, Bluetooth, Wi-Fi, GNSS, hotspot, and mobile network of the second user device. The trade module enables to trade at least one non-fungible token when the geographic information of the second user corresponds to the geographic information of the digital asset.

The payment module is configured to enable the second user to make payment to collect the desired non-fungible token. The payment module is further configured to share a revenue received from trading the non-fungible token to the first user. The payment module is further configured to share a predefined percentage of revenue to the first user, and share a predefined percentage of revenue to the first user on subsequent sale of the transferred non-fungible token.

In one embodiment, the information related to non-fungible token comprising digital assets and information related to digital assets. The information related to the digital asset includes, but not limited to, token name, collection name, series name, price, number of digital assets to retain, tags and text to be added to the tags. In one embodiment, the digital asset includes audio file video file, digital media file, and picture.

In one embodiment, a method for creating and managing non-fungible tokens is disclosed. The method is incorporated in the system comprising the computing device, the first user device associated with the first user, the second user device associated with the second user and the database. The computing device is in communication with the first user device, the second user device and the database via the network. The computing device further comprises a set of program modules and at least one processor configured to execute one or more modules stored in a memory. The modules comprise an input module, a location module, a tokenization module, a search module, a trade module and a payment module. At one step, the input module is configured to receive information related to at least one digital asset from the first user, and receive the digital asset from the first user.

At another step, the location module is configured to receive a geographic information determined by the first user to trade the digital asset and associate the digital asset to the geographic information. The geographic information includes a geographic boundary. The location module enables the first user to mark the geographic boundary on a geographic map and links the digital asset to the geographic boundary. The location module is configured to determine the geographic information of the first user using at least one of GPS, Global Navigation Satellite System (GNSS), Bluetooth, Wi-Fi, hotspot, and mobile network of the first user device.

At yet another step, the tokenization module is configured to create a non-fungible token (NFT) comprising the digital asset. At yet another step, the search module is configured to search one or more non-fungible tokens using one or more criteria received from the second user and display one or more non-fungible tokens relevant to the criteria. In one embodiment, the criteria include, but not limited to, token name, places, popular tokens, tags and location proximal to the second user to collect tokens.

At yet another step, the location module is further configured to determine a geographic information of the second user. The location module is configured to determine the geographic information of the second user using at least one of GPS, GNSS, Bluetooth, Wi-Fi, hotspot, and mobile network of the second user device.

At yet another step, the trade module enables to trade at least one non-fungible token when the geographic information of the second user corresponds to the geographic information of the digital asset. At yet another step, the payment module is configured to enable the second user to make payment to collect the desired non-fungible token. The payment module is further configured to share a revenue received from trading the non-fungible token to the first user. The payment module is further configured to share a predefined percentage of revenue to the first user, and share a predefined percentage of revenue to the first user on subsequent sale of the transferred non-fungible token.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 exemplarily illustrates an environment of a system for creating and managing non-fungible tokens, according to an embodiment of the present invention.

FIG. 2 exemplarily illustrates a block diagram of the computing device of FIG. 1.

FIG. 3 exemplarily illustrates a screenshot of a user interface to enable a first user to input information related to the digital asset, according to an embodiment of the present invention.

FIG. 4 exemplarily illustrates a screenshot of a user interface to upload a digital asset, according to an embodiment of the present invention.

FIG. 5 exemplarily illustrates a screenshot of a user interface to upload a digital asset comprising image and decorations, according to an embodiment of the present invention.

FIG. 6 exemplarily illustrates a screenshot of a user interface to upload a digital asset comprising videos and decorations, according to an embodiment of the present invention.

FIG. 7 exemplarily illustrates a screenshot of a user interface to upload a digital asset comprising audio and image, according to an embodiment of the present invention.

FIG. 8 exemplarily illustrates a screenshot of a user interface to upload a digital asset comprising a digital media file, according to an embodiment of the present invention.

FIG. 9 exemplarily illustrates a screenshot of a user interface to mark geographic boundary to link with the digital asset received from the first user, according to an embodiment of the present invention.

FIG. 10 exemplarily illustrates a screenshot of a user interface displaying the information related to the digital asset and the geographic boundary linked to the digital asset to create a non-fungible token (NFT), according to an embodiment of the present invention.

FIG. 11 exemplarily illustrates a screenshot of a user interface showing a created non-fungible token (NFT), according to an embodiment of the present invention.

FIG. 12 exemplarily illustrates a screenshot of a user interface displaying non-fungible tokens created by the first user, according to an embodiment of the present invention.

FIG. 13 exemplarily illustrates a screenshot of a user interface displaying non-fungible tokens of the first user, according to an embodiment of the present invention.

FIG. 14 exemplarily illustrates a screenshot of a user interface to prompt the user to turn on location in the user device, according to an embodiment of the present invention.

FIG. 15 exemplarily illustrates a screenshot of a user interface displaying a geographic map to mark a geographic boundary, according to one embodiment of the present invention.

FIG. 16 exemplarily illustrates a screenshot of a user interface displaying a geographic boundary marked on the geographic map by the user, according to another embodiment of the present invention.

FIG. 17 exemplarily illustrates a screenshot of a user interface to search the non-fungible tokens using one or more criteria, according to an embodiment of the present invention.

FIG. 18 exemplarily illustrates a screenshot of a user interface displaying the non-fungible token selected by the second user, according to an embodiment of the present invention.

FIG. 19. exemplarily illustrates a screenshot of a user interface indicating the location of the second user within the geographic boundary associated with the digital asset selected by the second user, according to an embodiment of the present invention.

FIG. 20 exemplarily illustrates a screenshot of a user interface indicating the location of the second user is outside the geographic boundary associated with the digital asset selected by the second user, according to an embodiment of the present invention.

FIG. 21 exemplarily illustrates a screenshot of a user interface displaying the non-fungible token selected by the user and the geographic information of the second user corresponds to the geographic information of the non-fungible token, according to an embodiment of the present invention.

FIG. 22 exemplarily illustrates a screenshot of a user interface for making payment and collect the non-fungible token, according to an embodiment of the present invention.

FIG. 23 exemplarily illustrates a screenshot of a user interface displaying the non-fungible token collected by the second user, according to an embodiment of the present invention.

FIG. 24 exemplarily illustrates a screenshot of a user interface displaying transaction details of the user, according to an embodiment of the present invention.

FIG. 25 exemplarily illustrates a screenshot of a user interface displaying a login page, according to an embodiment of the present invention.

FIG. 26 exemplarily illustrates a screenshot of a user interface displaying a search bar on the login page, according to an embodiment of the present invention.

FIG. 27 exemplarily illustrates a screenshot of a user interface to perform location-based search for NFTs, according to an embodiment of the present invention.

FIG. 28 exemplarily illustrates a screenshot of a user interface to perform profile-based search for NFTs, according to an embodiment of the present invention.

FIG. 29 exemplarily illustrates a screenshot of a user interface that enables the user to login, according to an embodiment of the present invention.

FIG. 30 exemplarily illustrates a screenshot of a user interface to add profile picture, according to an embodiment of the present invention.

FIG. 31 exemplarily illustrates a screenshot of a user interface to add profile related information of the user, according to an embodiment of the present invention.

FIG. 32 exemplarily illustrates a screenshot of a user interface displaying terms and conditions to drop a non-fungible token (NFT), according to an embodiment of the present invention.

FIG. 33 exemplarily illustrates a screenshot of a user interface to upload a digital asset, according to an embodiment of the present invention.

FIG. 34 exemplarily illustrates a screenshot of a user interface to draw a geographic boundary to link with the uploaded digital asset, according to an embodiment of the present invention.

FIG. 35 exemplarily illustrates a screenshot of a user interface to input information related to NFT, according to an embodiment of the present invention.

FIG. 36 exemplarily illustrates a screenshot of a user interface displaying NFT details for confirmation to drop NFT, according to an embodiment of the present invention.

FIG. 37 exemplarily illustrates a screenshot of a user interface displaying a location of the dropped NFT, according to an embodiment of the present invention.

FIG. 38 exemplarily illustrates a screenshot of a user interface displaying a geographic map with marked location to find NFTs, according to an embodiment of the present invention.

FIG. 39 exemplarily illustrates a screenshot of a user interface indicating the second user is within a geographic boundary of the NFT, according to an embodiment of the present invention.

FIG. 40 exemplarily illustrates a screenshot of a user interface displaying payment details to collect the NFT, according to an embodiment of the present invention.

FIG. 41 exemplarily illustrates a screenshot of a user interface displaying the payment details of collected NFT, according to an embodiment of the present invention.

FIG. 42 exemplarily illustrates a screenshot of a user interface displaying a NFT owned by the user, according to an embodiment of the present invention.

FIG. 43 exemplarily illustrates a screenshot of a user interface indicating the second user is within a geographic boundary of another NFT, according to an embodiment of the present invention.

FIG. 44 exemplarily illustrates a screenshot of a user interface displaying another NFT owned by the user, according to an embodiment of the present invention.

### DETAILED DESCRIPTION OF EXAMPLE EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

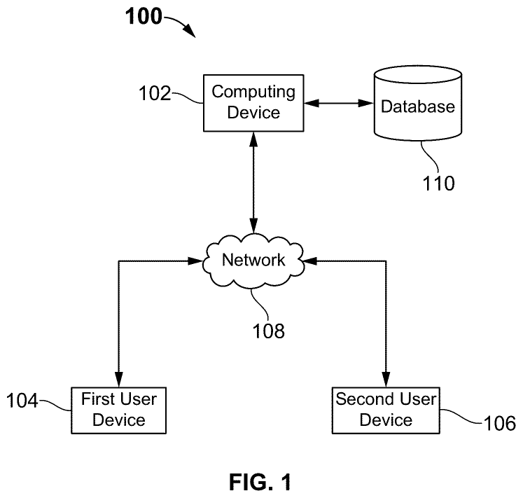

Referring to FIG. 1, an environment 100 comprises a computing device 102 in communication with a database 110 via a network 108. The environment 100 further comprises a first user device 104 associated with a first user and a second user device 106 associated with a second user. The first user device 104 and the second user device 106 are in communication with the computing device 102 via a network 108. The environment 100 further includes at least one database 110 in communication with the computing device 102. The first user refers to a creator of a non-fungible token. The second user refers to the user desire to collect the non-fungible tokens.

The computing device 102 is configured to receive information related to at least one digital asset from the first user. The computing device 102 is configured to receive the digital asset from the first user. The computing device 102 is further configured to receive a geographic information determined by the first user to trade the digital asset. The computing device 102 is further configured to associate the digital asset to the geographic information. The geographic information comprises a geographic boundary.

The computing device 102 is configured to create a non-fungible token (NFT) comprising the digital asset. The computing device 102 is configured to provide ownership of the digital assets to the first user. The computing device 102 is further configured to enable the second user to search for one or more non-fungible tokens using one or more criteria. The computing device 102 is further configured to display one or more non-fungible tokens relevant to the criteria defined by the second user. The computing device 102 is further configured to determine a geographic information of the second user. The computing device 102 is further configured to enable the second user to trade the non-fungible token when the geographic information of the second user corresponds to the geographic information of the digital asset.

The first user device 104 and the second user device 106 also commonly referred as user device (104, 106). The first user and the second user are also commonly referred as user. The user device (104, 106) is a computing device configured to provide access to the service provided by the computing device 102. The user device (104, 106) is configured to provide an interface to access the services provided by the computing device 102. The interface, for example, an application that allows the user device (104, 106) to wirelessly connect with the computing device 102 via the network 108. The user device (104, 106) may be, for example, a desktop computer, a laptop computer, a mobile phone, a personal digital assistant, and the like.

The network 108 generally represents one or more interconnected networks, over which the user device (104, 106) and the computing device 102 can communicate with each other. The network 108 may include packet-based wide area networks (such as the Internet), local area networks (LAN), private networks, wireless networks, satellite networks, cellular networks, paging networks, and the like. A person skilled in the art will recognize that the network 108 may also be a combination of more than one type of network. For example, the network 108 may be a combination of a LAN and the Internet. In addition, the network 108 may be implemented as a wired network, a wireless network or a combination thereof.

In one embodiment, the computing device 102 is at least one of a general or special purpose computer. In one embodiment, the computing device 102 is a server. In another embodiment, the computing device 102 operates as a single computer, which can be a hardware and/or software server, a workstation, a desktop, a laptop, a tablet, a mobile phone, a mainframe, a supercomputer, a server farm, and so forth. In an embodiment, the computer could be touchscreen and/or non-touchscreen device and could run on any type of OS, such as iOS™, Windows™, Android™, Unix™, Linux™ and/or others. In an embodiment, the user device (104, 106) is in communication with the computing device 102 via the network 108. Such communication can be via a software application, a mobile app, a browser, an OS, and/or any combination thereof.

In an embodiment, the database 110 may be accessible by the computing device 102. In another embodiment, the database 110 may be integrated into the computing device 102 or separate from it. In an embodiment, at least one database 110 resides in a connected computing device 102 or a cloud computing service. In an embodiment, regardless of location, the database 110 comprises a memory to store and organize data for use by the computing device 102. In one embodiment, the database 110 stores information related to the first user, information related to the second user, information related to non-fungible token comprising digital assets and information related to digital assets.

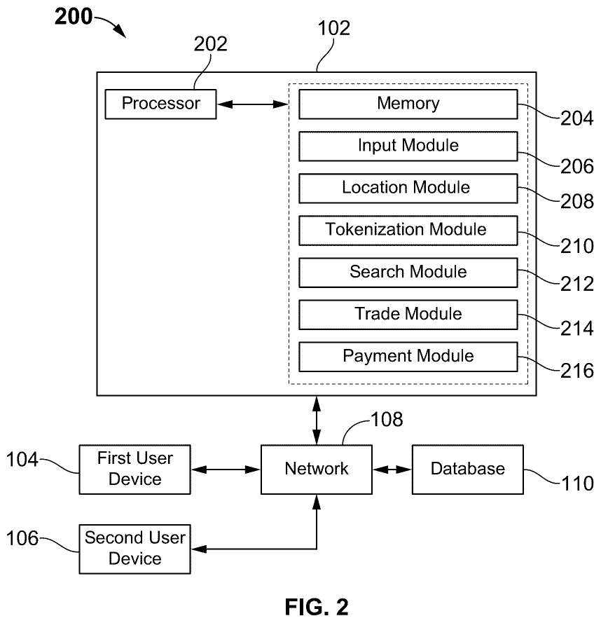

FIG. 2 exemplarily illustrates a block diagram 200 of the computing device 102 of FIG. 1. The computing device 102 comprises one or more processors 202 and one or more memories 204. The processor 202 is configured to execute one or more program modules. The program modules comprise an input module 206, a location module 208, a tokenization module 210, a search module 212, a trade module 214 and a payment module 216.

The input module 206 is configured to receive information related to at least one digital asset from the first user. The information includes, but not limited to, token name, collection name, series name, price, number of digital assets to retain, tags and text to be added to the tags. The input module 206 is further configured to receive at least one digital asset from the first user. The digital asset includes, but not limited to, audio file, video file, picture, digital media file. The location module 208 is further configured to receive a geographic information determined by the first user to trade the digital asset. The geographic information includes a geographic boundary. Each digital asset is associated with a geographic boundary. The tokenization module 210 is configured to mint or generate a non-fungible token (NFT) comprising the digital asset.

The search module 212 enables the second user to input one or more criteria to search for one or more tokens. The criteria include, but not limited to, token name, places, popular tokens, tags and location proximal to the second user to collect tokens. The search module 212 is further configured to display one or more non-fungible tokens relevant to the criteria received from the second user.

The location module 208 is configured to determine a geographic information of the second user. In one embodiment, the location module 208 is configured to determine the geographic information of the first user using a geo positioning system (GPS) in the first user device 104. In one embodiment, the location module 208 is configured to determine the geographic information of the second user using a geo positioning system in the second user device 106. The location module 208 is configured to determine the location of the second user using at least one of GPS, Bluetooth, Global Navigation Satellite System (GNSS), Wi-Fi, hotspot, and mobile network of the second user device 106. When the second user desires to collect at least one NFT, the location module 208 is configured to determine the geographic information of the second user. Further, the location module 208 is configured to determine whether the geographic location of the second user is within the geographic boundary of the corresponding NFT comprising the digital asset. The system enables the second user to collect or trade the NFT, when the geographic location of the second user corresponds to the geographic location mapped to the corresponding digital asset.

The trade module 214 in communication with the location module 208 is configured to enable the second user to collect one or more non-fungible tokens, when a geographic location of the second user corresponds to the geographic location mapped to the digital asset. The trade module 214 enables the second user to collect or trade one or more no-fungible tokens.

The payment module 216 is configured to enable the second user to make payment to collect the desired non-fungible token. The payment module 216 is further configured to share the revenue received from trading the non-fungible token to the first user. The payment module 216 is configured to share a predefined percentage of revenue to the first user. The payment module 216 is configured to share a predefined percentage of revenue to the first user on subsequent sale of the transferred non-fungible token.

In one embodiment, a method for creating and managing non-fungible tokens are disclosed. The method is incorporated in the system comprising the computing device 102, the first user device 104 associated with the first user, the second user device 106 associated with the second user and the database 110. The computing device 102 is in communication with the first user device 104, the second user device 106 and the database 110 via the network 108. The computing device 102 comprises one or more processors 202 and one or more memories 204. The processor 202 is configured to execute one or more program modules. The program modules comprise an input module 206, a location module 208, a tokenization module 210, a search module 212, a trade module 214 and a payment module 216.

At one step, the input module 206 is configured to receive information related to at least one digital asset from the first user, and receive the digital asset from the first user.

At another step, the location module 208 is configured to receive a geographic information determined by the first user to trade the digital asset and associate the digital asset to the geographic information. The geographic information includes a geographic boundary. The location module 208 enables the first user to mark the geographic boundary on a geographic map and links the digital asset to the geographic boundary. The location module 208 is configured to determine the geographic information of the first user using at least one of GPS, GNSS, Bluetooth, Wi-Fi, hotspot, and mobile network of the first user device.

At yet another step, the tokenization module 210 is configured to create a non-fungible token (NFT) comprising the digital asset.

At yet another step, the search module 212 is configured to search one or more non-fungible tokens using one or more criteria received from the second user and display one or more non-fungible tokens relevant to the criteria. In one embodiment, the criteria include, but not limited to, token name, places, popular tokens, tags and location proximal to the second user to collect tokens.

At yet another step, the location module 208 is further configured to determine a geographic information of the second user. The location module 208 is configured to determine the geographic information of the second user using at least one of GPS, GNSS, Bluetooth, Wi-Fi, hotspot, and mobile network of the second user device.

At yet another step, the trade module 214 enables to trade at least one non-fungible token when the geographic information of the second user corresponds to the geographic information of the digital asset.

At yet another step, the payment module 216 is configured to enable the second user to make payment to collect the desired non-fungible token. The payment module 216 is further configured to share a revenue received from trading the non-fungible token to the first user. The payment module 216 is further configured to share a predefined percentage of revenue to the first user, and share a predefined percentage of revenue to the first user on subsequent sale of the transferred non-fungible token.

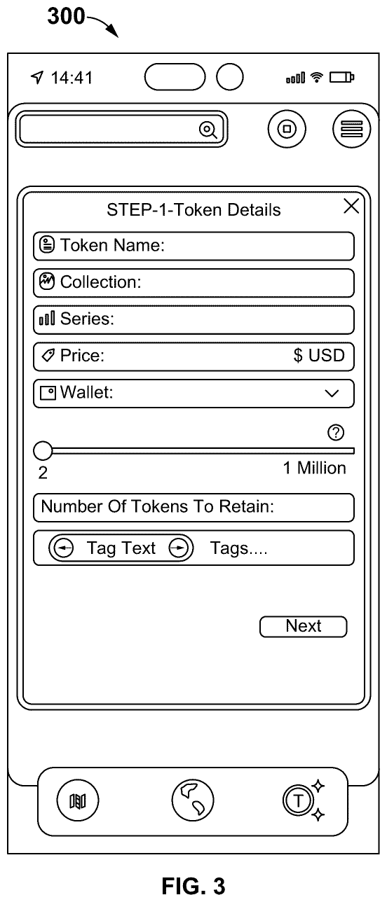

FIG. 3 exemplarily illustrates a screenshot 300 of a user interface to enable the first user to input information related to the digital asset, according to an embodiment of the present invention. The information includes, but not limited to, token name, collection name, series name, price, number of digital assets to retain, tags, text to be added to the tags.

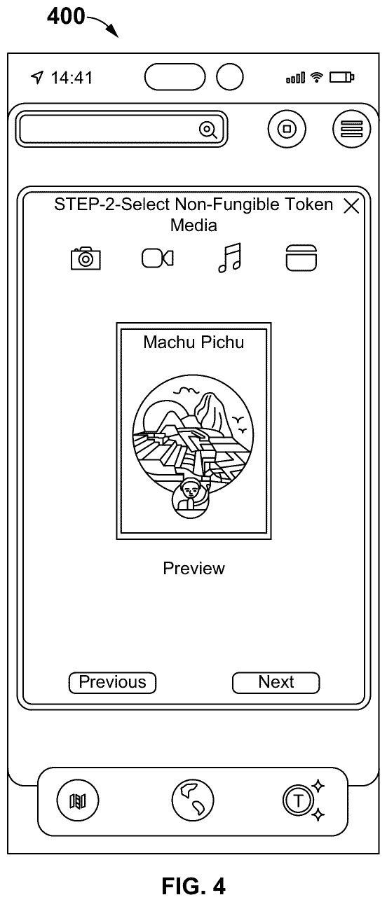

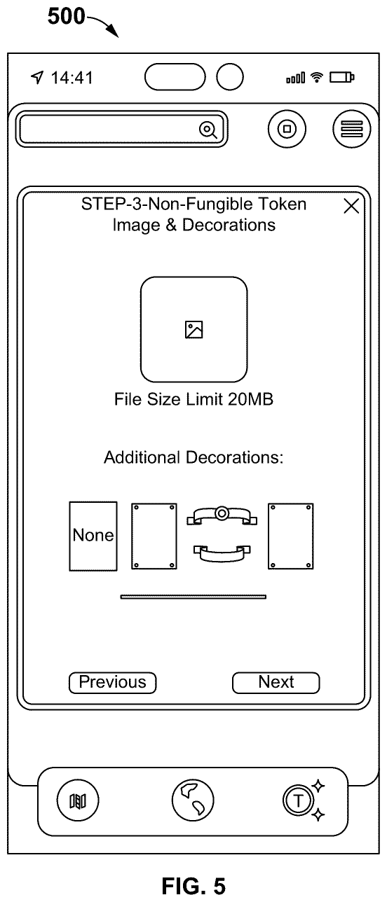

FIG. 4 exemplarily illustrates a screenshot 400 of a user interface to upload digital asset, according to an embodiment of the present invention. The digital asset includes, but not limited to, image, audio, video and digital files. FIG. 5 exemplarily illustrates a screenshot 500 of a user interface to upload the digital asset comprising image and decorations, according to an embodiment of the present invention. The user interface enables the first user to upload one or more images.

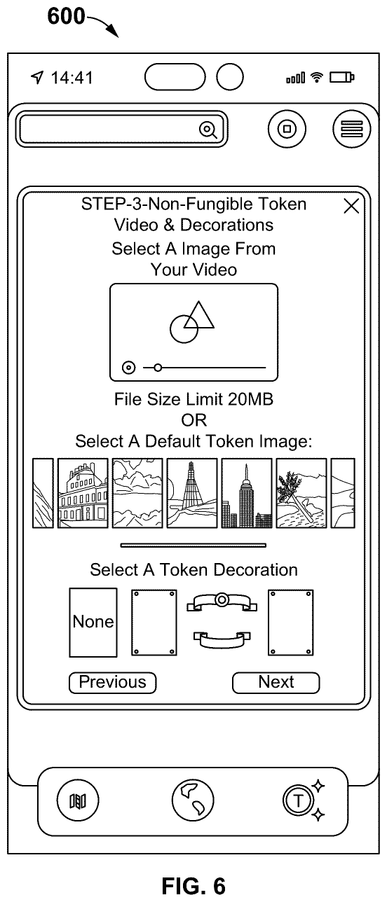

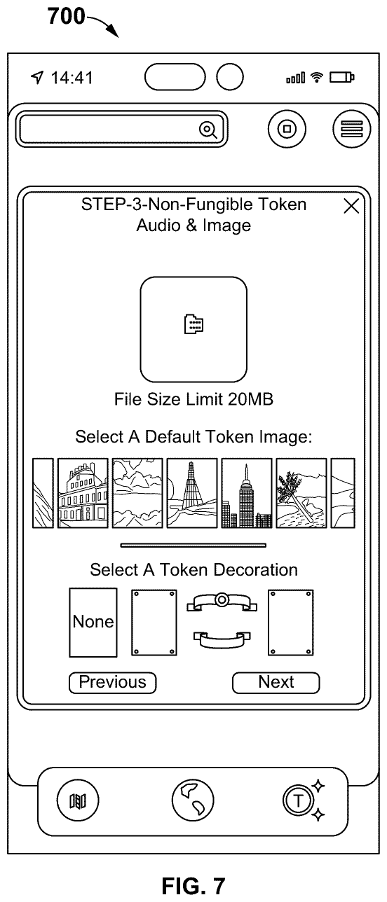

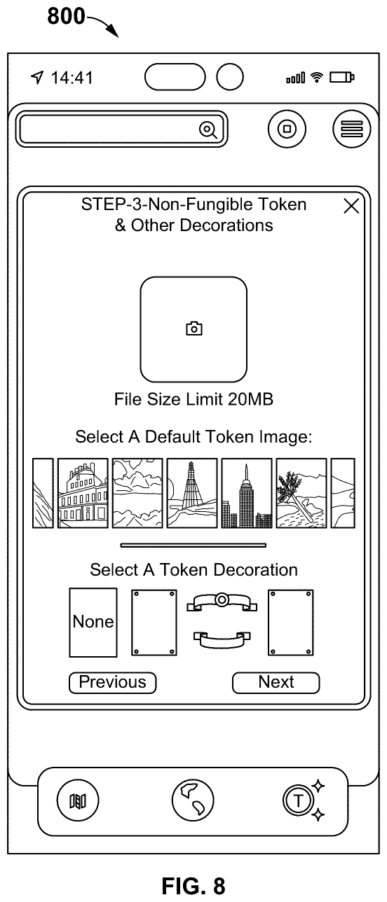

FIG. 6 exemplarily illustrates a screenshot 600 of a user interface to upload a digital asset comprising videos and decorations, according to an embodiment of the present invention. The user interface enables the first user to upload one or more videos. The user interface further enables the first user to add decorations to the non-fungible token. FIG. 7 exemplarily illustrates a screenshot 700 of a user interface to upload a digital asset comprising audio and image, according to an embodiment of the present invention. FIG. 8 exemplarily illustrates a screenshot 800 of a user interface to upload a digital asset comprising a digital media file, according to an embodiment of the present invention. Referring to FIG. 5 to FIG. 8, the user interface further enables the first user to add decorations to the non-fungible token.

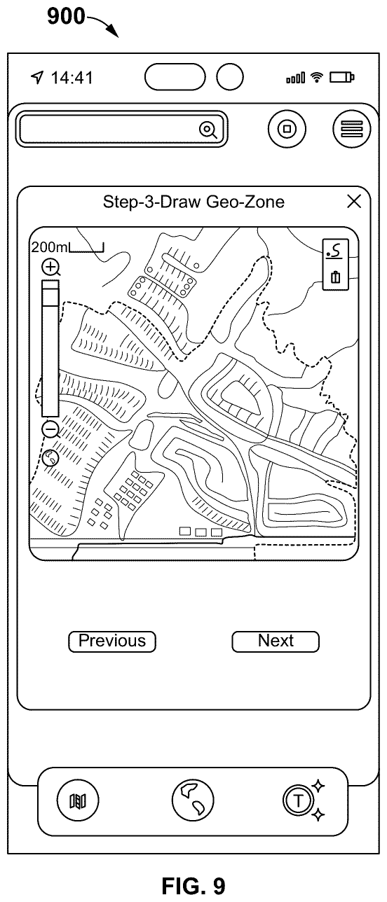

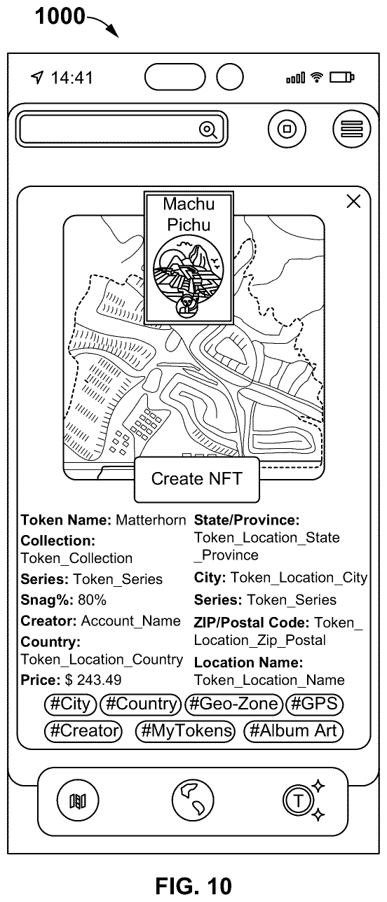

FIG. 9 exemplarily illustrates a screenshot 900 of a user interface to mark geographic boundary to link with the digital asset received from the first user, according to an embodiment of the present invention. The user interface enables the first user to mark a geographic boundary or a geofence to link the digital asset uploaded by the first user to the geofence. FIG. 10 exemplarily illustrates a screenshot 1000 of a user interface displaying the information related to the digital asset and the geographic boundary linked to the digital asset to create a non-fungible token (NFT), according to an embodiment of the present invention. The user interface enables the first user to confirm the details of the non-fungible token and create the NFT.

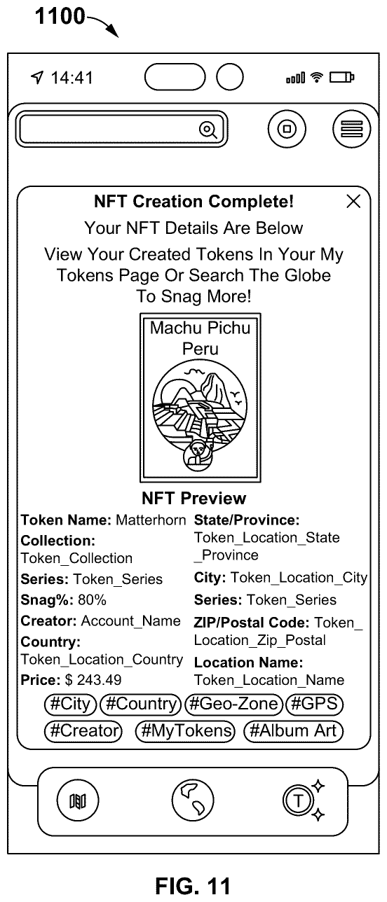

FIG. 11 exemplarily illustrates a screenshot 1100 of a user interface showing a created non-fungible token (NFT), according to an embodiment of the present invention.

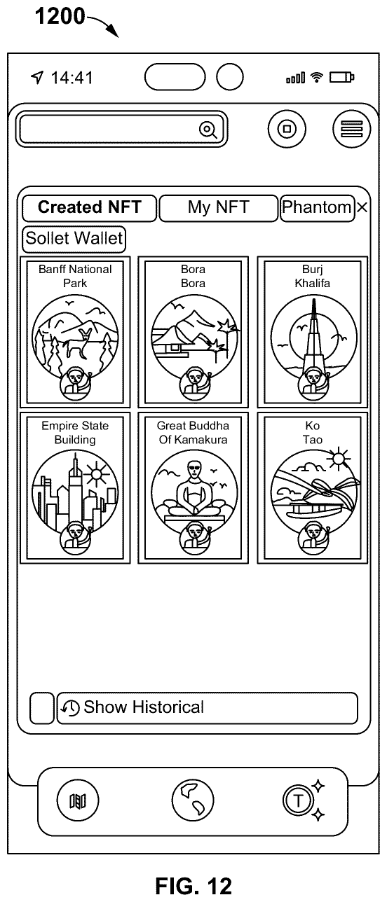

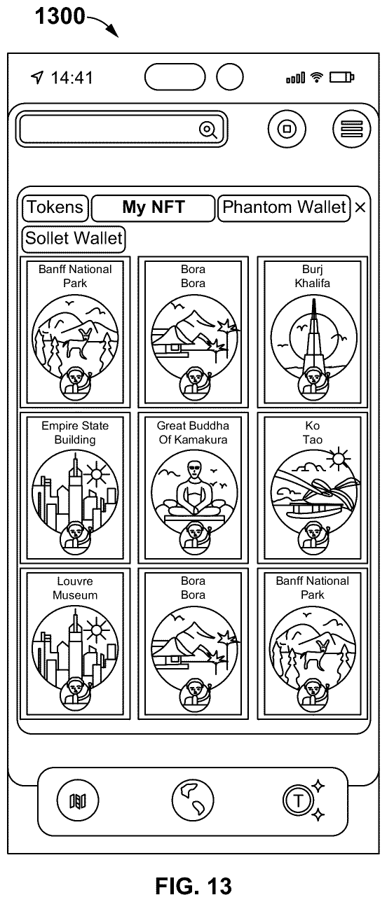

The user interface further displays the information of the NFT. The information includes, but not limited to, token name, collection type, series, country of origin, state, city and price. FIG. 12 exemplarily illustrates a screenshot 1200 of a user interface displaying non-fungible tokens created by the first user, according to an embodiment of the present invention. The user interface displays a list of non-fungible tokens created by the first user. FIG. 13 exemplarily illustrates a screenshot 1300 of a user interface displaying non-fungible tokens of the first user, according to an embodiment of the present invention. The user interface displays a list of non-fungible tokens owned by the first user.

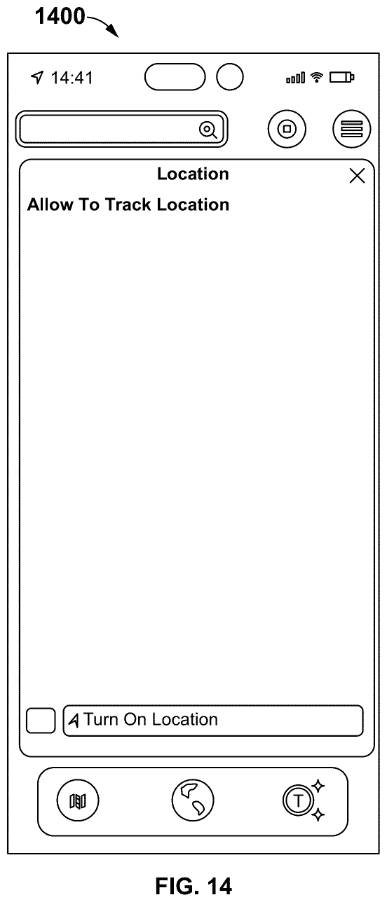

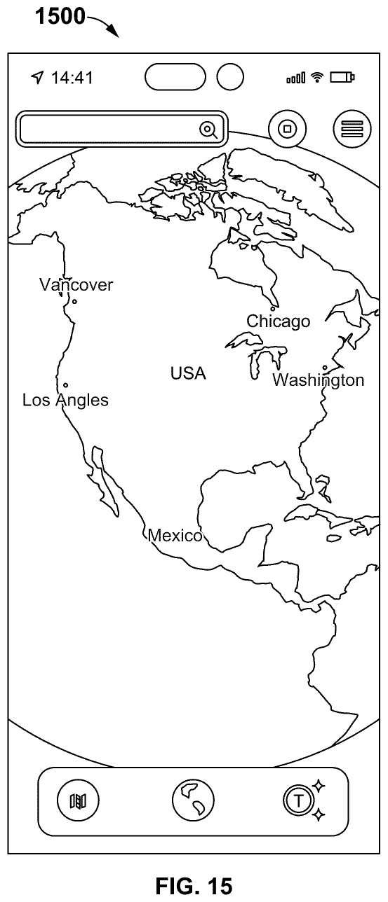

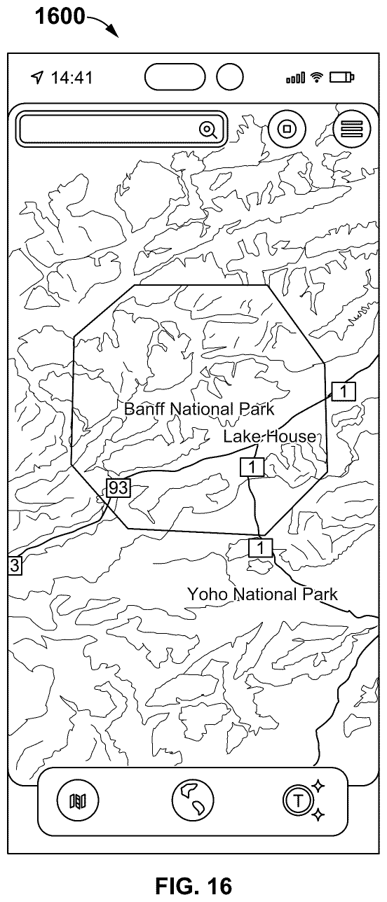

FIG. 14 exemplarily illustrates a screenshot 1400 of a user interface to prompt the user to turn on location in the user device, according to an embodiment of the present invention. FIG. 15 exemplarily illustrates a screenshot 1500 of a user interface displaying geographic map to mark a geographic boundary, according to one embodiment of the present invention. FIG. 16 exemplarily illustrates a screenshot 1600 of a user interface displaying a geographic boundary marked on the geographic map by the user, according to another embodiment of the present invention.

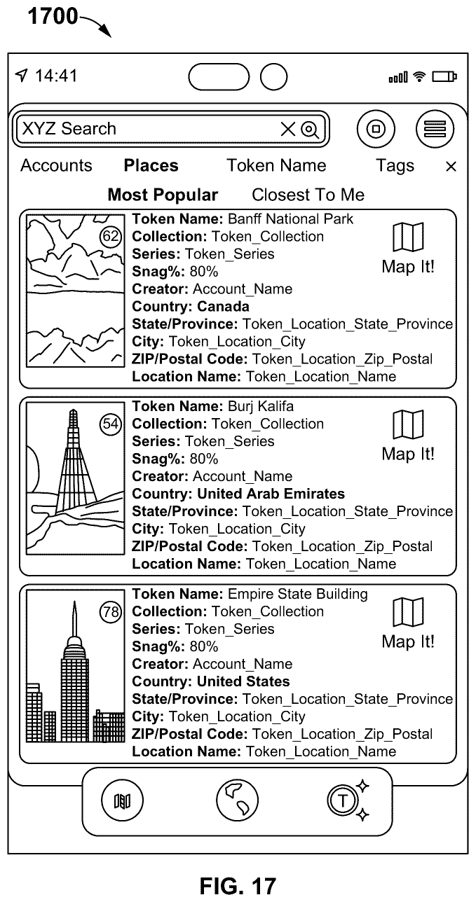

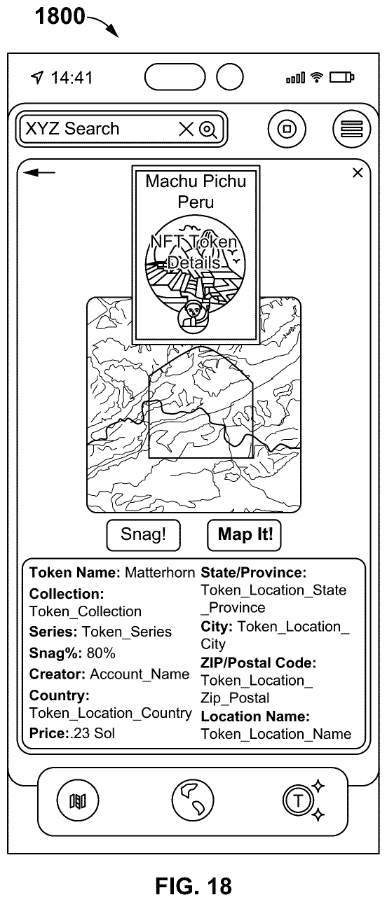

FIG. 17 exemplarily illustrates a screenshot 1700 of a user interface to search the non-fungible tokens using one or more criteria, according to an embodiment of the present invention. The criteria include, but not limited to, location, token name and tags. FIG. 18 exemplarily illustrates a screenshot 1800 of a user interface displaying the non-fungible token selected by the second user, according to an embodiment of the present invention. The user interface displays the NFTs relevant to the criteria provided by the second user.

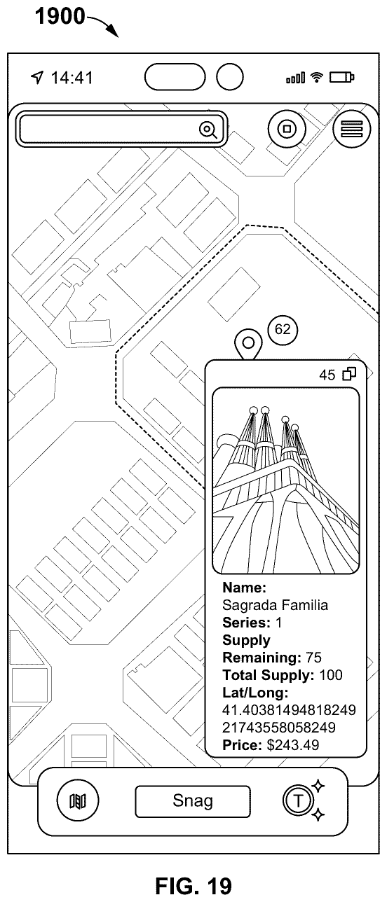

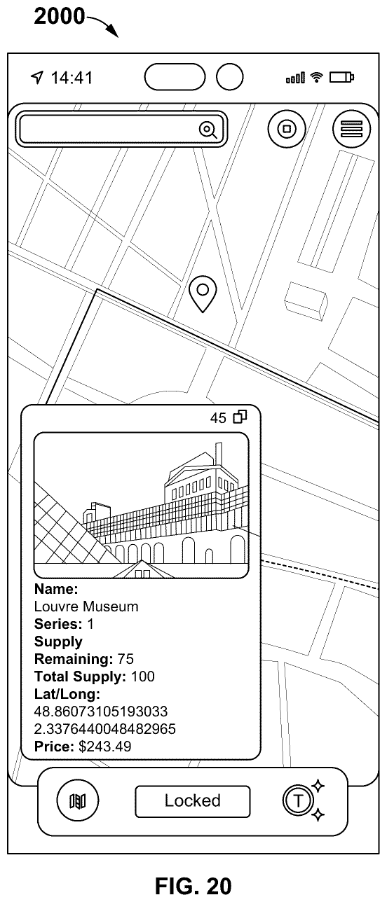

FIG. 19. exemplarily illustrates a screenshot 1900 of a user interface indicating the location of the second user within the geographic boundary associated with the digital asset selected by the second user, according to an embodiment of the present invention. FIG. 20 exemplarily illustrates a screenshot 2000 of a user interface indicating the location of the second user is outside the geographic boundary associated with the digital asset selected by the second user, according to an embodiment of the present invention.

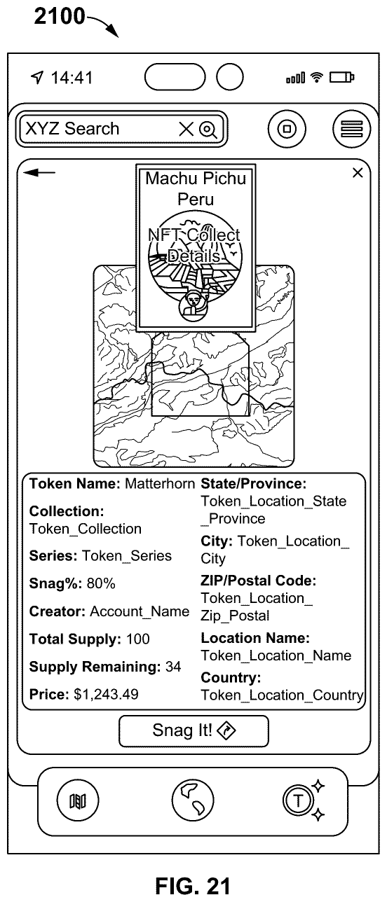

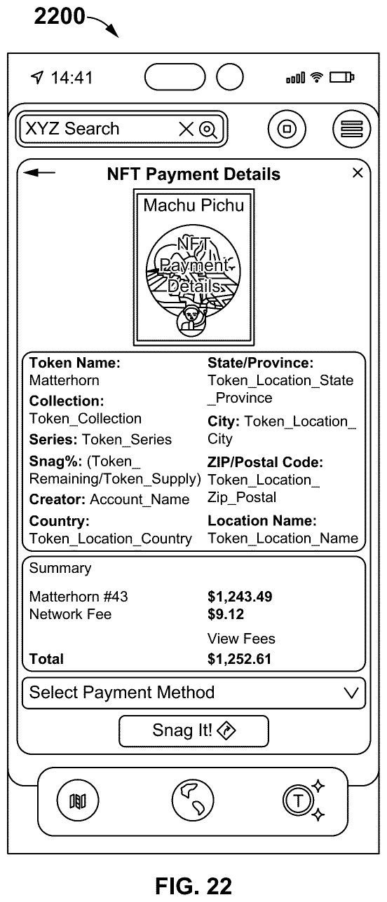

FIG. 21 exemplarily illustrates a screenshot 2100 of a user interface displaying the non-fungible token selected by the second user and the geographic information of the second user corresponds to the geographic information of the non-fungible token, according to an embodiment of the present invention. The user interface provides an option to collect or trade the NFT when the geographic information of the second user corresponds to the geographic information of the non-fungible token. FIG. 22 exemplarily illustrates a screenshot 2200 of a user interface for making payment and collect the non-fungible token, according to an embodiment of the present invention.

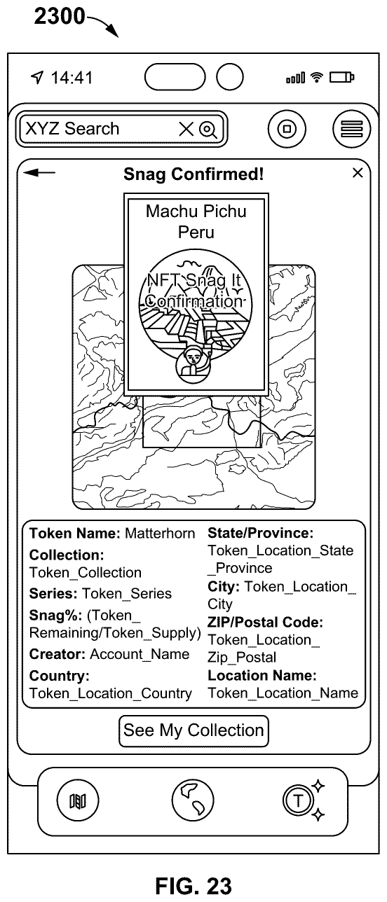

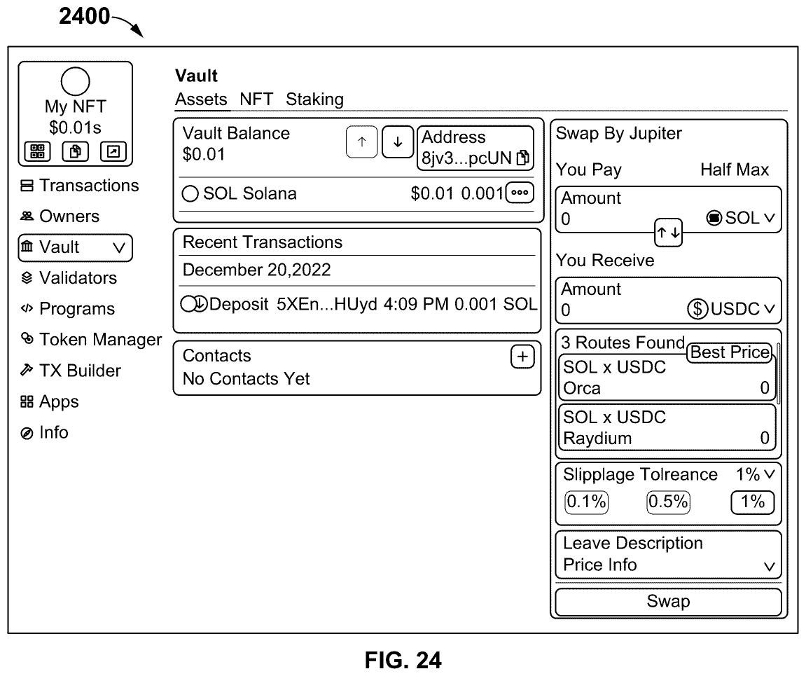

FIG. 23 exemplarily illustrates a screenshot 2300 of a user interface displaying the non-fungible token collected or purchased by the second user, according to an embodiment of the present invention. FIG. 24 exemplarily illustrates a screenshot 2400 of a user interface displaying transaction details of the user, according to an embodiment of the present invention. The transaction details, includes, but not limited to, vault balance, recent transactions, contacts, the amount paid, amount received and slippage tolerance. In one embodiment, the system could be incorporated in an event hosted in a particular location. The event, for example, includes a promotion event, customer appreciation event, a giveaway event, a concert and a sport event. The system is configured such that the user needs to visit the location of the event to collect the NFTs associated with the location of the event. According to the present invention, a machine-readable code is provided to the users visiting the event. The machine-readable code, for example, a quick response (QR) code. The user could scan the QR code via the user device, which provides a user interface to enable the users to collect the non-fungible token.

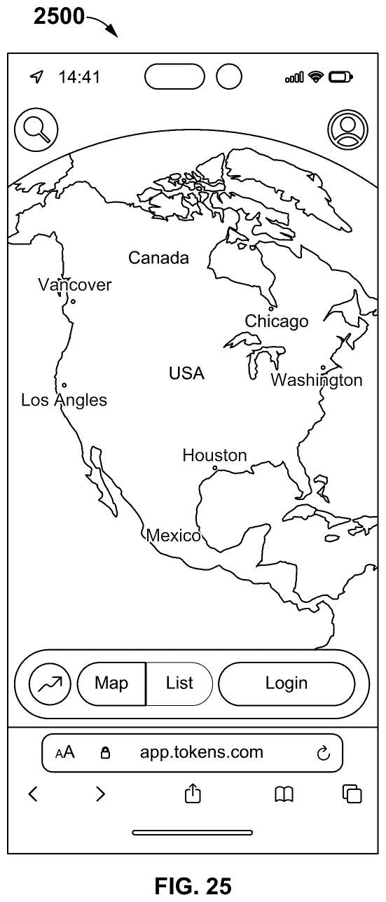

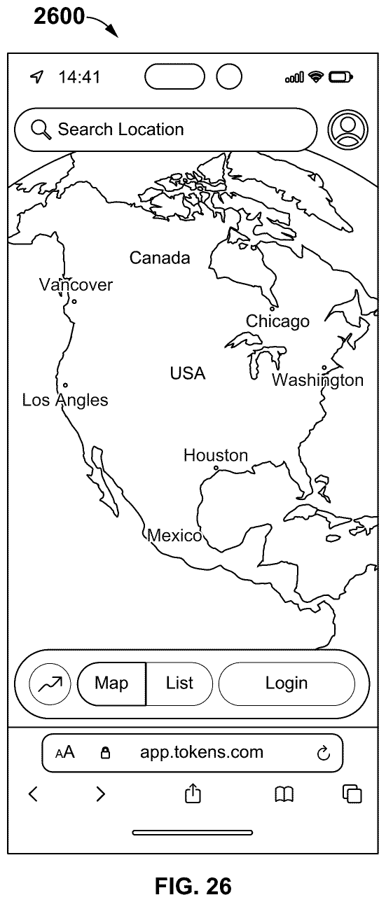

FIG. 25 exemplarily illustrates a screenshot 2500 of a user interface displaying a login page, according to an embodiment of the present invention. The login page displays one or more options. The options include map, list, and login option. FIG. 26 exemplarily illustrates a screenshot 2600 of a user interface displaying a search bar on the login page, according to an embodiment of the present invention. Further, the search bar enables to search NFTs based on one or more criteria.

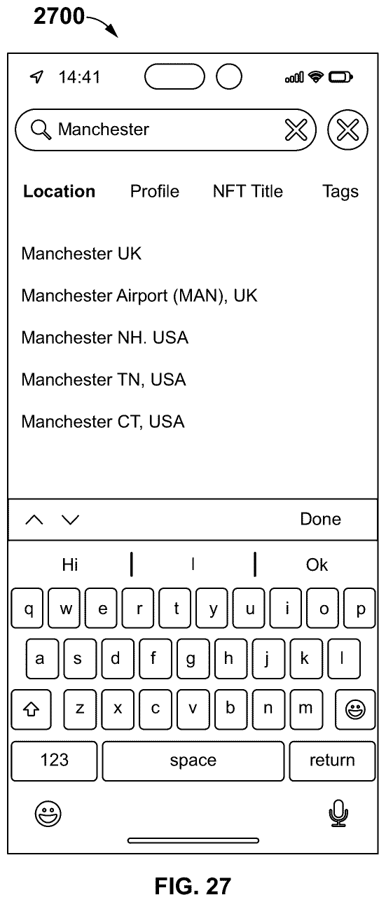

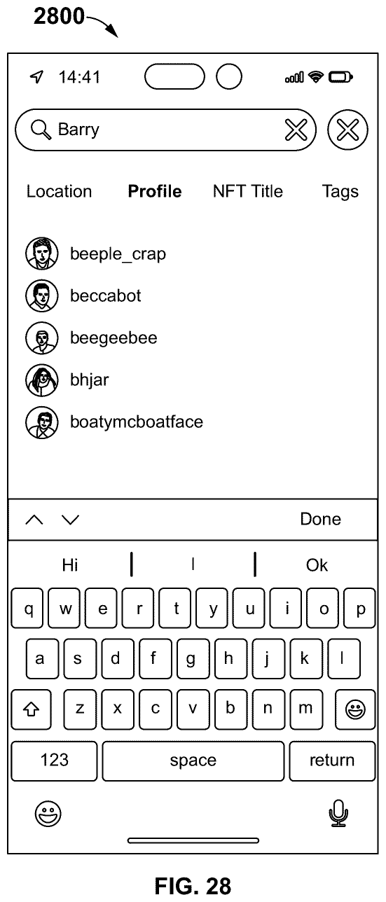

FIG. 27 exemplarily illustrates a screenshot 2700 of a user interface to perform location-based search for NFTs, according to an embodiment of the present invention. FIG. 28 exemplarily illustrates a screenshot 2800 of a user interface to perform profile-based search for NFTs, according to an embodiment of the present invention. The user interface suggests locations and profiles as they are entered in the search bar, which enhances the user experience.

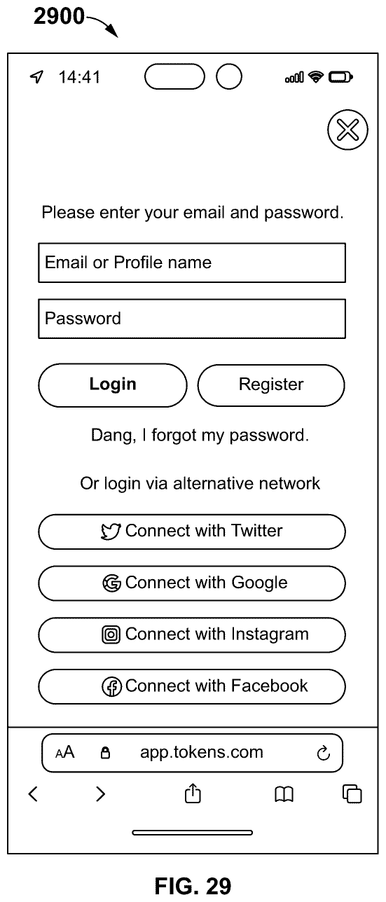

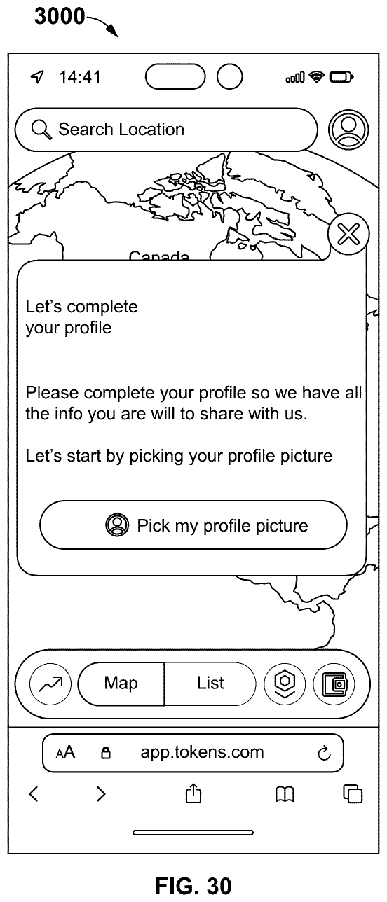

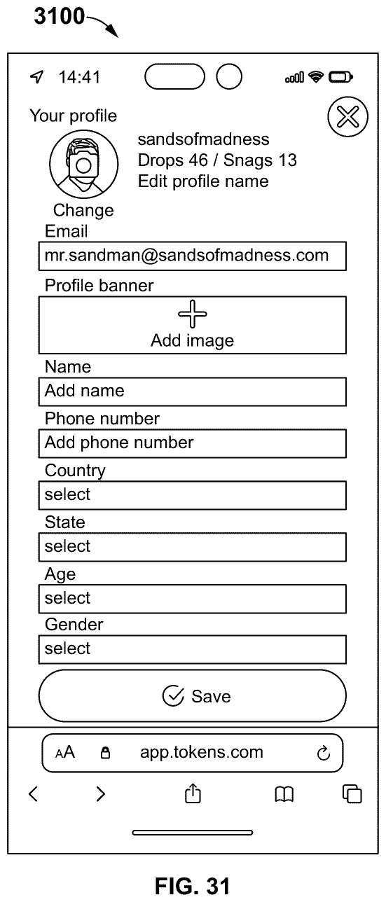

FIG. 29 exemplarily illustrates a screenshot 2900 of a user interface that enables the user to login, according to an embodiment of the present invention. The user could login using a profile name or Email ID and a password. Further, the user interface provides a register option to enables new user to register. FIG. 30 exemplarily illustrates a screenshot 3000 of a user interface to add profile picture, according to an embodiment of the present invention. FIG. 31 exemplarily illustrates a screenshot 3100 of a user interface to add profile related information of the user, according to an embodiment of the present invention. The information includes, but not limited to, email, profile image, first name, last name, phone number, country, address, city, post code, state, age, and gender. Further, the information is saved by clicking on the save option.

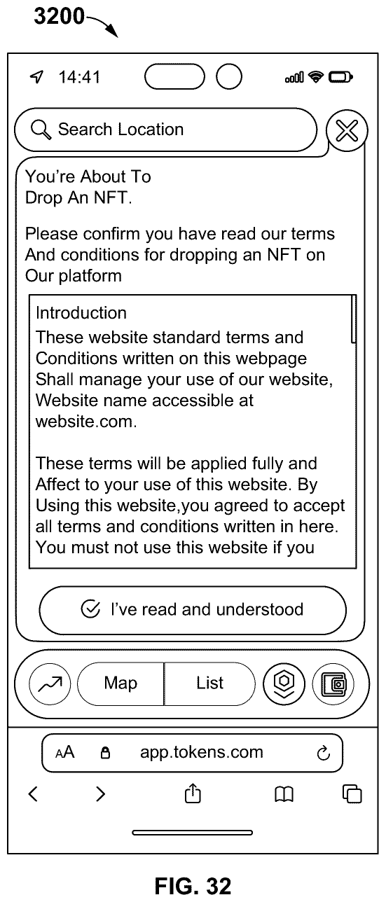

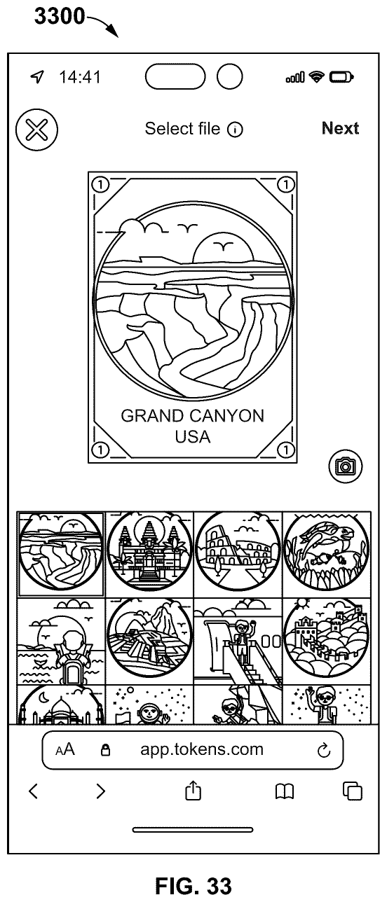

FIG. 32 exemplarily illustrates a screenshot 3200 of a user interface displaying terms and conditions to drop a non-fungible token (NFT), according to an embodiment of the present invention. The user interface enables the user to review and agree to the terms and conditions before dropping their non-fungible tokens (NFTs). FIG. 33 exemplarily illustrates a screenshot 3300 of a user interface to upload a digital asset, according to an embodiment of the present invention. The digital asset, includes, but not limited to, photos.

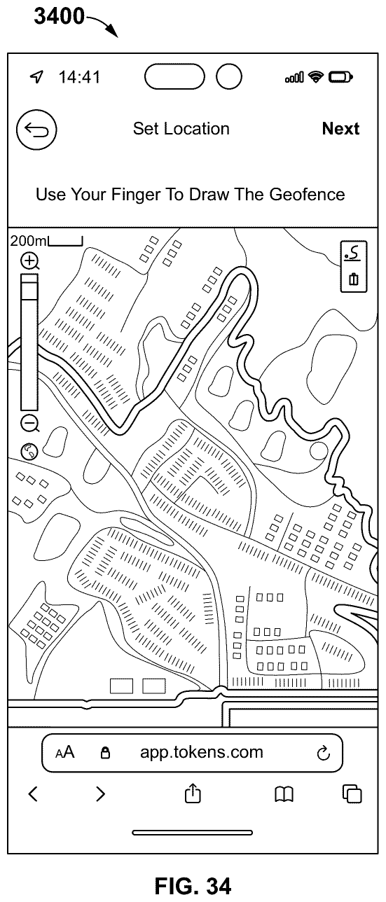

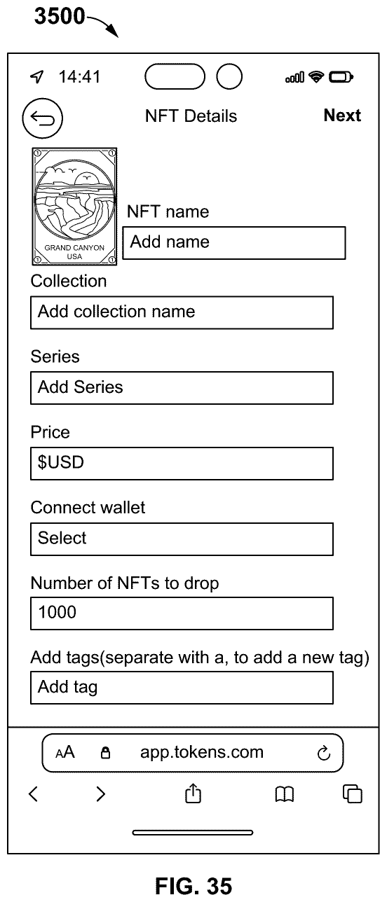

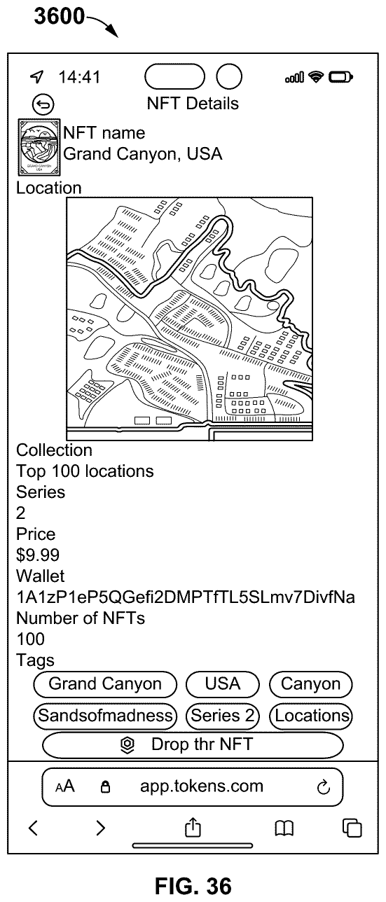

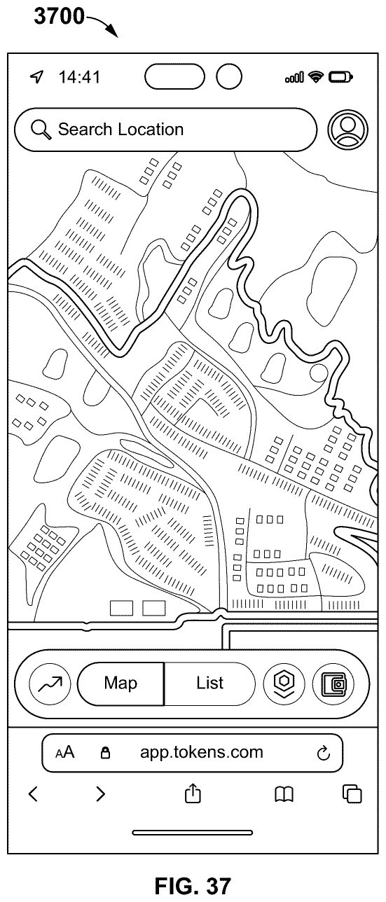

FIG. 34 exemplarily illustrates a screenshot 3400 of a user interface to draw geographic boundary to link with the uploaded digital asset, according to an embodiment of the present invention. The user interface enables the first user to draw a geographic boundary or a geofence. Further, the geographic boundary or the geofence is linked to the uploaded digital asset. FIG. 35 exemplarily illustrates a screenshot 3500 of a user interface to input information related to NFT, according to an embodiment of the present invention. The information related to NFT, includes, but not limited to, NFT name, collection, series, price, connect wallet, numbers of NFTs to drop, and add tags. FIG. 36 exemplarily illustrates a screenshot 3600 of a user interface displaying NFT details for confirmation to drop NFT, according to an embodiment of the present invention. The user interface enables the user to review and confirm the details of the NFT. FIG. 37 exemplarily illustrates a screenshot 3700 of a user interface displaying a location of the dropped NFT, according to an embodiment of the present invention.

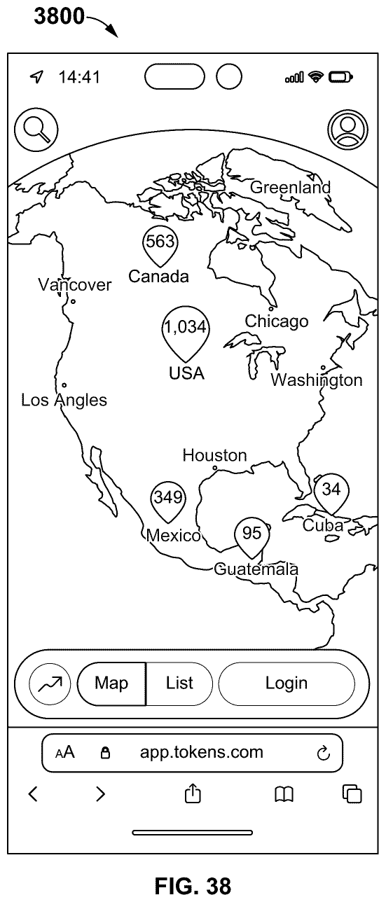

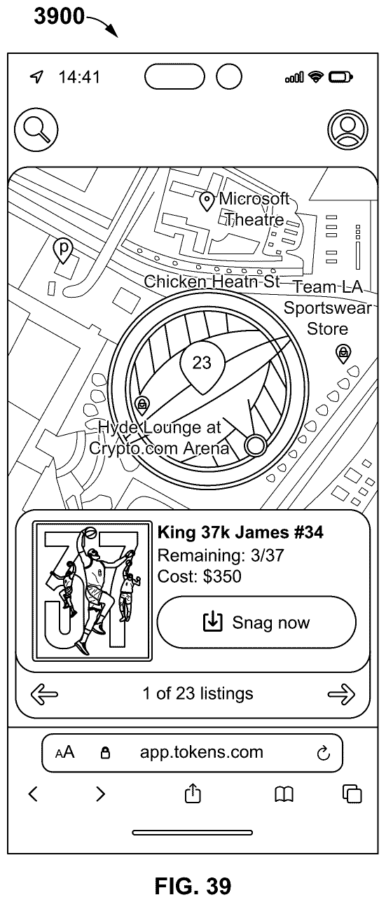

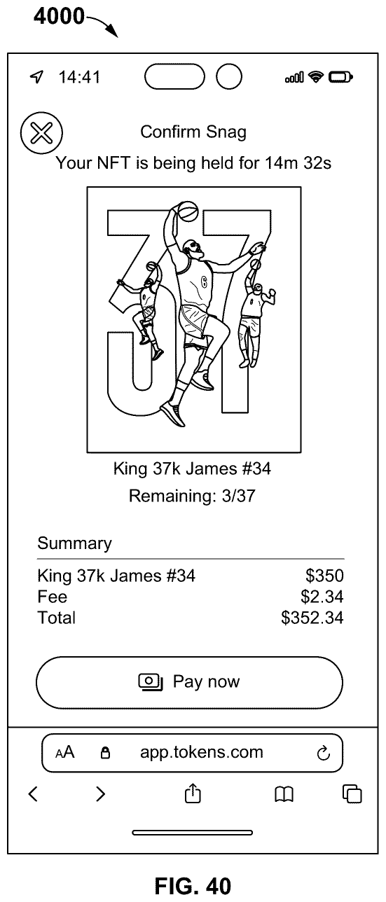

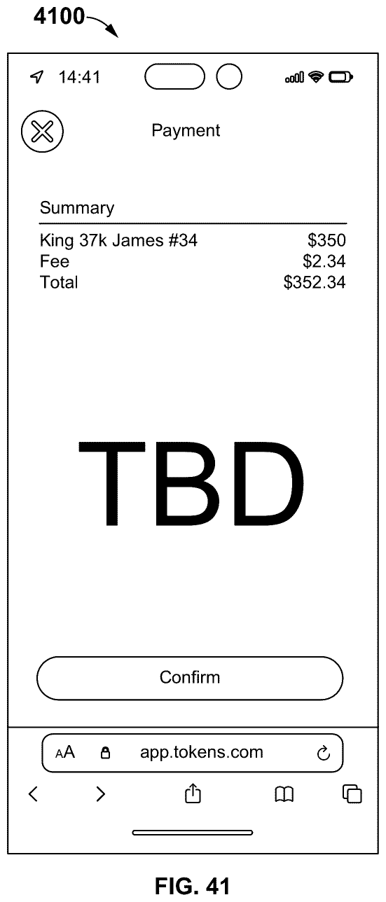

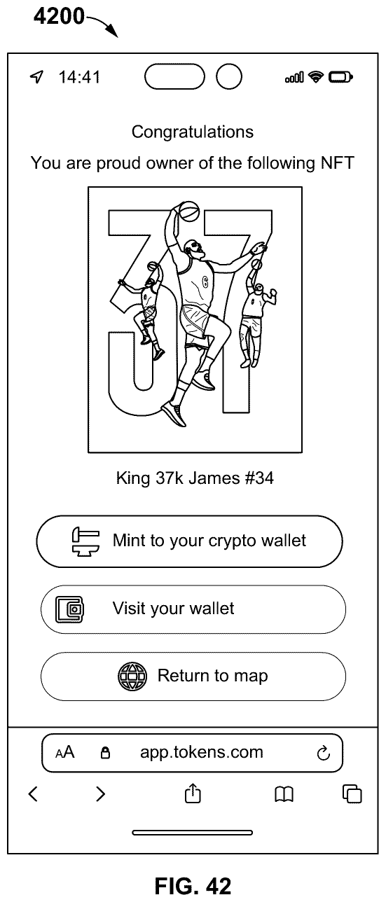

FIG. 38 exemplarily illustrates a screenshot 3800 of a user interface displaying a geographic map with marked location to find NFTs, according to an embodiment of the present invention. FIG. 39 exemplarily illustrates a screenshot 3900 of a user interface indicating the second user is within a geographic boundary of the NFT, according to an embodiment of the present invention. Further, the user could collect the NFT within the marked geographic boundary. FIG. 40 exemplarily illustrates a screenshot 4000 of a user interface displaying payment details to collect the NFT, according to an embodiment of the present invention. Further, the user interface has a summary of the payment to collect the NFT. FIG. 41 exemplarily illustrates a screenshot 4100 of a user interface displaying the payment details of collected NFT, according to an embodiment of the present invention. FIG. 42 exemplarily illustrates a screenshot 4200 of a user interface displaying a NFT owned by the user, according to an embodiment of the present invention. Further, user interface displays one or more option. The option, includes, but not limited to, mint to your crypto wallet, visit your token wallet, and to return to map.

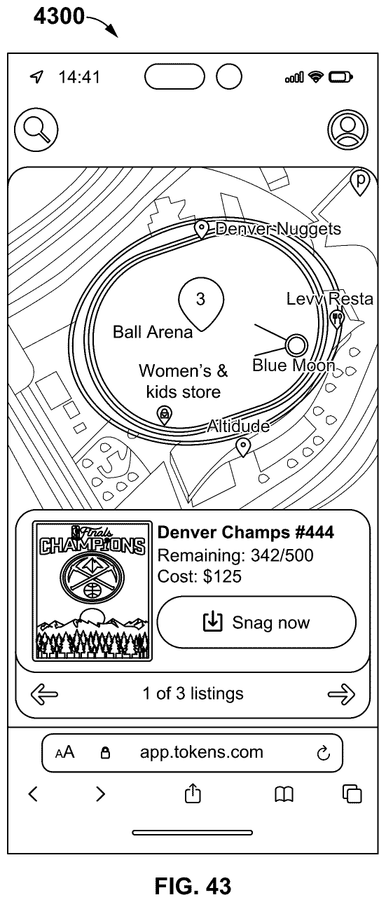

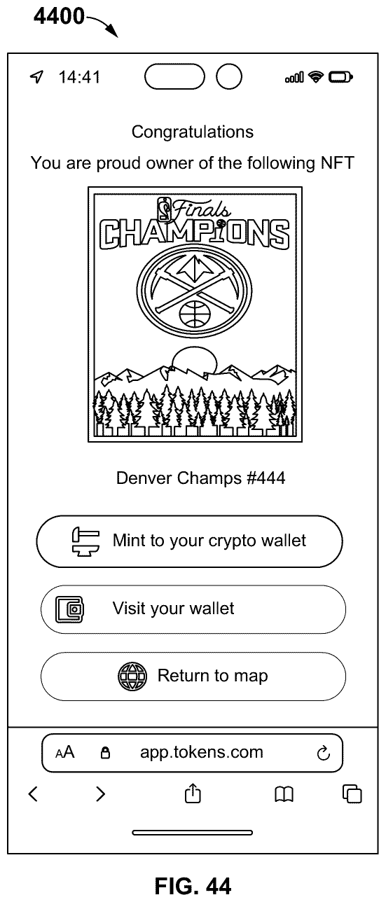

FIG. 43 exemplarily illustrates a screenshot 4300 of a user interface indicating the second user is within a geographic boundary of another NFT token, according to an embodiment of the present invention. FIG. 44 exemplarily illustrates a screenshot 4400 of a user interface displaying another NFT owned by the user, according to an embodiment of the present invention. Further, the user interface displays one or more options. The options, includes, but not limited to, mint to your crypto wallet, visit your token wallet, and return to map.

In one embodiment, the system could be configured to collect NFT from an event hosted in a particular location. The event, for example, includes but not limited to, a promotion event, customer appreciation event, a giveaway event, a greet and meet of an influencer, a concert, a sport event. In one embodiment, the system enables to connect users to renowned brands, influencers, artists, and businesses. Further, the system is configured to ensure that the user visits the location of the event to collect the NFTs associated with the location of the event. The system is a user-friendly platform that transforms the world into a dynamic NFT marketplace.

In another embodiment, the system could be configured to collect NFTs from a particular location, for example, a night club and a tourist location. The non-fungible tokens comprise digital files related to influencers and celebrities. The non-fungible tokens further comprise limited edition digital files related to influencers and celebrities. The non-fungible tokens further comprise digital files related to sceneries. The system is configured to provide ownership of the digital assets to the first user. The revenue received from transferring the non-fungible token to the second user is shared to the first user. The system is configured to share a predefined percentage of revenue to the first user. The system receives the revenue from sales and commissions of the digital asset transaction. The system is further configured to share a predefined percentage of revenue on subsequent sale of the transferred non-fungible token.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A system for creating and managing non-fungible tokens, comprising:
a first user device associated with a first user;
a second user device associated with a second user;
at least one database storing information related to the first user, information related to the second user and information related to the non-fungible tokens, and
at least one computing device in communication with the first user device, the second user device and the database via a network, wherein the computing device comprises a set of program modules and at least one processor configured to execute one or more modules stored in a memory, wherein the set of modules comprises:
an input module configured to receive information related to at least one digital asset from the first user, and receive the digital asset from the first user,
a location module configured to receive a geographic information determined by the first user to trade the digital asset and associate the digital asset to the geographic information, wherein the geographic information includes a geographic boundary,
a tokenization module configured to create a non-fungible token (NFT) comprising the digital asset,
a search module configured to search one or more non-fungible tokens using one or more criteria received from the second user and display one or more non-fungible tokens relevant to the criteria,
the location module configured to determine a geographic information of the second user, and
a trade module enables to trade at least one non-fungible token when the geographic information of the second user corresponds to the geographic information of the digital asset.

2. The system of claim 1, wherein the location module enables the first user to mark the geographic boundary on a geographic map and links the digital asset to the geographic boundary.

3. The system of claim 1, wherein the location module is configured to determine the geographic information of the second user using at least one of GPS, GNSS, Bluetooth, Wi-Fi, hotspot, and mobile network of the second user device.

4. The system of claim 1, wherein the location module is configured to determine the geographic information of the first user using at least one of GPS, GNSS, Bluetooth, Wi-Fi, hotspot, and mobile network of the first user device.

5. The system of claim 1, wherein the modules further comprise a payment module configured to enable the second user to make payment to collect the desired non-fungible token.

6. The system of claim 5, wherein the payment module is configured to share a revenue received from trading the non-fungible token to the first user.

7. The system of claim 5, wherein the payment module is configured to share a predefined percentage of revenue to the first user, and share a predefined percentage of revenue to the first user on subsequent sale of the transferred non-fungible token.

8. The system of claim 1, wherein the information related to non-fungible token comprising digital assets and information related to digital assets, and wherein the information related to the digital asset includes token name, collection name, series name, price, number of digital assets to retain, tags and text to be added to the tags.

9. The system of claim 1, wherein the digital asset includes audio file video file, digital media file, and picture.

10. The system of claim 1, wherein the criteria include token name, places, popular tokens, tags and location proximal to the second user to collect tokens.

11. A method for creating and managing non-fungible tokens, comprising the steps of:
providing a first user device associated with a first user, a second user device associated with a second user, at least one database, at least one computing device in communication with the first user device, the second user device and the database via a network, wherein the computing device comprises a set of program modules and at least one processor configured to execute one or more modules stored in the memory, wherein the database stores information related to the first user, information related to the second user and information related to the non-fungible tokens;
receiving, at the computing device via an input module, information related to at least one digital asset from the first user, and receiving the digital asset from the first user;
receiving, at the computing device via a location module, a geographic information determined by the first user to trade the digital asset and associating the digital asset to the geographic information, wherein the geographic information includes a geographic boundary;
creating, at the computing device via a tokenization module, a non-fungible token (NFT) comprising the digital asset;
searching, at the computing device via a search module, one or more non-fungible tokens using one or more criteria received from the second user and displaying one or more non-fungible tokens relevant to the criteria;
determining, at the computing device via the location module, a geographic information of the second user, and
enabling, at the computing device via a trade module, to trade at least one non-fungible token when the geographic information of the second user corresponds to the geographic information of the digital asset.

12. The method of claim 11, further comprising a step of: enabling, at the computing device via the location module, the first user to mark the geographic boundary on a geographic map to the digital asset to the geographic boundary.

13. The method of claim 11, further comprising the step of: determining, at the computing device via the location module, the geographic information of the second user using at least one of GPS, GNSS, Bluetooth, Wi-Fi, hotspot, and mobile network of the second user device.

14. The method of claim 11, further comprising the step of: determining, at the computing device via the location module, the geographic information of the first user using at least one of GPS, GNSS, Bluetooth, Wi-Fi, hotspot, and mobile network of the first user device.

15. The method of claim 11, further comprising the step of: enabling, at the computing device via a payment module, the second user to make payment to collect the desired non-fungible token.

16. The method of claim 15, further comprising the step of: sharing, at the computing device via the payment module, a revenue received from trading the non-fungible token to the first user.

17. The method of claim 15, further comprising the step of: sharing, at the computing device via the payment module, a predefined percentage of revenue to the first user, and sharing a predefined percentage of revenue to the first user on subsequent sale of the transferred non-fungible token.

18. The method of claim 11, wherein the information related to non-fungible token comprising digital assets and information related to digital assets, and wherein the information related to the digital asset includes token name, collection name, series name, price, number of digital assets to retain, tags and text to be added to the tags.

19. The method of claim 11, wherein the digital asset includes audio file video file, digital media file, and picture.

20. The method of claim 11, wherein the criteria include token name, places, popular tokens, tags and location proximal to the second user to collect tokens.
